(19) United States
(12) Patent Application Publication
(10) Pub. No.: US 2009/0276315 A1
(43) Pub. Date: Nov. 5, 2009

(54) MULTIMEDIA ADVERTISEMENTS IN A SPONSORED SEARCH ENVIRONMENT

(75) Inventors: Gulshan Verma, Mumbai (IN); Sunil Varhadkar, Mumbai (IN); Sandeep Shrivastava, Bangalore (IN)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/258,842

(22) Filed: Oct. 27, 2008

(30) Foreign Application Priority Data
May 2, 2008 (IN) 1095/CHE/2008

(51) Int. Cl. G06Q 30/00; G06Q 20/00

(52) U.S. Cl. 705/14.54; 705/14.73; 705/14.58; 705/14.69

(57) ABSTRACT

A method and system for displaying advertisement listings in a sponsored search environment is provided. The method and system may include receiving at a server located within a network location a search term corresponding to a search request by a searcher via a user terminal, selecting at least one multimedia advertisement associated with the search term, generating a search result including links to websites associated with the search term and information corresponding to the selected at least one multimedia advertisement, and communicating the search result to the searcher via the user terminal. The multimedia advertisements may be selected based on the geographic location of the searcher. The multimedia advertisements may include rich graphical information, audio, and/or video information. The information may be embedded in the search result or a link to the information may be provided within the search result. The link may refer to first server or a different server at a different network location.

### CLAIM FOR FOREIGN PRIORITY

This patent application claims the benefit of the filing date under 35 U.S.C. §119(a)-(d) or (f), or §365(b) of Indian Patent Application Serial No. 1095/CHE/2008, filed May 2, 2008, which is incorporated herein by reference.

### BACKGROUND

The Internet has emerged as a powerful tool for finding information. Various search engines are now available that enable searchers, via a web browser, to search for information on a variety of topics. For example, an internet user looking for a specific topic or web page may navigate to a website hosting a search engine and submit a search term, such as “restaurants” to the search engine. After submitting the search term, the search engine may provide a search result list to the internet user. The search result list may include a list of websites, which may include the search term.

These search services may be provided free of charge to the internet user. However, to cover the cost for these services, some search providers may include advertisements within or displayed within proximity to the search result list. Advertisers may pay the search providers to have their advertisements listed along with other websites in the search result list. In some instances, the advertiser's may pay to have their advertisements associated with search terms that may be related to the search terms submitted by the internet user. This may allow the advertiser to target advertisements to internet users that may be more likely to purchase the advertiser's products or services. This type of arrangement has come to be known as sponsored search because the advertisers are essentially sponsoring the internet users search. The search services providing these services have come to be called sponsored search providers.

One problem with existing systems, however, is that advertisements in the search result list are only text based. Thus, the effectiveness of the advertisement may be limited. Moreover, there may be a limit to the amount of text that can be utilized. This may make it difficult for an advertiser to get his advertising message across to the searcher.

### BRIEF SUMMARY

To address the problems outlined above, a method and system for displaying advertisement listings in a sponsored search environment is provided. The method and system may include receiving at a server located within a network location a search term corresponding to a search request by a searcher via a user terminal, selecting at least one multimedia advertisement associated with the search term, generating a search result including links to websites associated with the search term and information corresponding to the selected at least one multimedia advertisement, and communicating the search result to the searcher via the user terminal. The multimedia advertisements may be selected based on the geographic location of the searcher. The multimedia advertisements may include rich graphical information, audio, and/or video information. The information may be embedded in the search result or a link to the information may be provided within the search result. The link may refer to first server or a different server at a different network location.

### BRIEF DESCRIPTION OF THE DRAWINGS

FIG. 1 is a diagram of a system for providing a sponsored search result web page with multimedia advertisements;

FIG. 2a is a web page with a photographic multimedia advertisement;

FIG. 2b is a web page with a video multimedia advertisement

FIG. 3 is a flow diagram for generating a web page with multimedia advertisements;

FIG. 4 is a flow diagram for retrieving a multimedia advertisement;

FIG. 5 is flow diagram for displaying multimedia information on an internet browser; and

FIG. 6 illustrates a general computer system, which may represent any of the computing devices referenced herein.

### DETAILED DESCRIPTION OF THE DRAWINGS AND THE PRESENTLY PREFERRED EMBODIMENTS

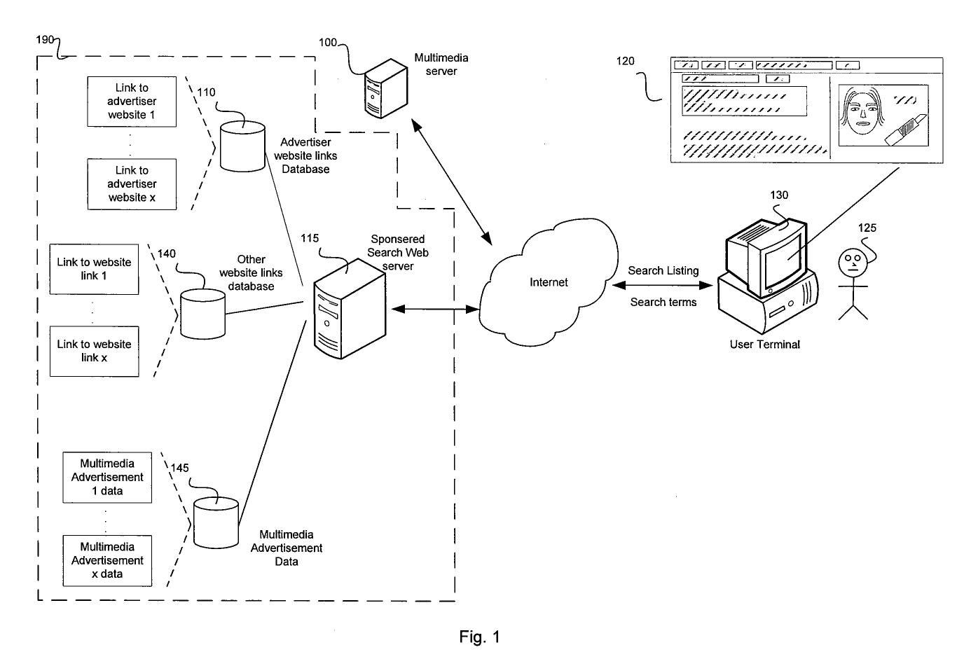

FIG. 1 is a diagram of a system 190 for providing a sponsored search result web page with multimedia advertisements. The system 190 includes an advertisement listing database 110, a database with website links 140, a multimedia advertisement database 145, a sponsored search web server 115, a multimedia. Also shown in FIG. 1 is a multimedia server 100, a user terminal 130, a search result web page 120, and a searcher 125.

The sponsored search web server 115 may comprise suitable logic, code, and or circuitry that may enable generating web pages, such as a search result web page 120. For example, a program such as Apache™ or Microsoft Internet Information Server™ may be utilized to generate the web pages. The sponsored search web server 115 may be implemented using any conventional computer or other data processing device. The sponsored search web server 115 may further be implemented using a specialized data processing device, which has been particularly adapted to performing the functions of a sponsored search web server 115. These functions may include communicating with a searcher 125 via an internet browser running on a user terminal 130. The sponsored search web server 115 may also be adapted to communicate with other networked equipment and to retrieve information from various databases, such as an advertisement listing database 110, a database with website links 140, and/or a multimedia advertisement database 145. The information communicated may include data defining text, images, video, audio or other information.

The user terminal 130 may comprise suitable logic, code, and or circuitry that may enable communicating information over a network connection, such as an internet connection. For example, the user terminal 130 may correspond to an Intel™ based computer running a Windows™ operating system with a browser, such as Internet Explorer™ The user terminal 130 may be adapted to display web pages communicated from a web server, such as the search result web page 120 generated by the sponsored search web server 115. For example, the user terminal 130 may include an internet browser that may enable displaying web pages. In addition to displaying graphical information, the internet browser may also be utilized to execute instructions. For example, the internet browser may execute instructions in the form of scripts, such as Java script or any other scripting language. The user terminal 130 may also be adapted to communicate search terms to the sponsored search web server 115 and to communicate defining text, images, video, audio or other information from other servers, such as a multimedia server 100.

The multimedia server 100 may comprise suitable logic, code, and or circuitry that may enable communicating information over a network connection, such as an internet connection. For example, the multimedia server 100 may correspond to an Intel™ based computer running a Windows™ or Linux operating system with streaming software such as P2P-Next™ The multimedia server 100 may be adapted to communicate with other networked devices via an application program interface (API) that enables sending and receiving information to and from the multimedia server 100. For example, via the API the user terminal 130 and/or the sponsored search web server 115 may communicate data, such as images, video, audio or other information, from the multimedia server 100. The API may correspond to a set of interface functions for interacting with the multimedia server 100.

The advertiser database 110, the database with website links 140, and the multimedia advertisement database 145 may be in communication with the sponsored search web server 115. The advertiser database 110 may include advertisement listings associated with various advertisers. The advertisement listings may be associated with various search terms. Advertisers may have paid an operator of the sponsored search web server 115 to have their respective advertisement listings associate with various search terms so that their respective advertisement listings may be displayed to a searcher 125 searching for information based on a search term.

The database with website links 140 may include a series of links to other websites as well as search terms that may be incorporated in those websites. The database with website links 140 may, for example, be populated by executing a web crawler algorithm on the internet. This algorithm may search the internet for websites and collect terms found on the websites for association with the website and store links to the websites along with their associated terms.

The multimedia advertisement database 145 may include information necessary to generate multimedia advertisements. This information may be utilized by the sponsored search web server 115 to generate multimedia advertisement in the search result web page 120. The multimedia advertisements in the multimedia advertisement database 145 may be associated with search terms. Advertisers may have paid an operator of the sponsored search web server 115 to have their respective multimedia advertisements associated with various search terms so that their respective advertisement listings may be displayed to a searcher 125 searching for information based on a search term.

The information stored for each multimedia advertisement may include images, video, and/or audio data that may enable generating a multimedia advertisement in a web browser operating on the user terminal 130. For example, a photographic picture advertisement may be represented utilizing a JPEG format. A video advertisement may be represented in an MPEG format. The information may also include links to servers for streaming the multimedia information. These links may be utilized to retrieve multimedia information from a server. For example, an advertiser may provide a multimedia server 100 and may prefer that a video advertisement originates from this server. An internet browser operating on the user terminal 130 may then connect to the server via the link and stream the multimedia information from the server. An advantage to this approach may be that it enables the advertiser to update the multimedia advertisement without having to go through the owner of the sponsored search web server 115. This may save the advertiser time in getting the advertisement message to market.

In operation, the searcher 125 may, through an internet browser running on the user terminal 130, navigate to a search website hosted on the sponsored search web server 115 and specify search terms. The search terms may be communicated to the sponsored search web server 115, which may then communicate the search result web page 120 to the user terminal 130. The search result web page 120 may include links to advertiser web pages and other web pages that may be related to search terms provided by the searcher 125. The sponsored search web server 115 may accomplish this by searching through the advertisement listing database 110 and the database with website links for any advertisement listings and other websites that may have search terms associated with the search terms provided by the searcher 125. If any are found, the corresponding advertisement listings and links to other websites 105 and 135 may be included in the search result web page 120.

In addition, multimedia advertisements may be included in the search result web page 120. This may be accomplished by searching through the multimedia advertisement database 145 for any multimedia advertisements that may be associated with the search terms provided by the searcher 125. The sponsored search web server 115 may take into consideration the geographic location of the searcher 125 and may retrieve multimedia advertisements that may be more geographically relevant to the searcher 125. If any are found, the corresponding information stored in the database with multimedia advertisement data 145 may be utilized by the sponsored search web server 115 to generate a multimedia advertisement. For example, images, video, and/or audio corresponding to the multimedia advertisement may be embedded in the internet browser code and may enable displaying the multimedia advertisement on the internet browser operating on the user terminal 130. In addition or alternatively, the sponsored search web server 115 may include links to multimedia advertisements stored on the multimedia server 100. These links may enable streaming multimedia information, such as video and/or audio from the multimedia server 100 to the user terminal 130.

Upon receiving the search result web page 120, the internet browser may convert embedded multimedia information so as to display an image, audio, or video advertisement in the internet browser. For example, a photographic picture may be displayed. Video advertisements may be displayed as well. In some instances, the multimedia advertisement may be streamed to the internet browser operating on the user terminal 130. For example, a link to the multimedia server 100 may enable streaming the multimedia advertisement from the multimedia server 100. The multimedia server 100 may be located within the same network as the sponsored search web server 115. The multimedia server 100 may also reside on the same hardware utilized for the sponsored search web server 115. Alternatively, the multimedia server 100 may reside within a different network, such as an advertisers computer network and the network may be coupled to the user terminal 130 and/or the sponsored search web server 115 via a network connection, such as an internet connection.

A searcher 125 viewing the search result web page 120 may then view the multimedia advertisement. For example, the searcher may watch a video. The searcher may be able to pause and rewind the video. The searcher 125 may also click on the multimedia advertisement to find out more information. For example, the internet browser may be directed to another web page with more information when the searcher 125 clicks on the multimedia advertisement. In addition or alternatively clicking the advertisement may initiate a telephone call to a call center associated with the multimedia advertisement. For example, the internet browser may initiate a telephone call via a modem in the user terminal 130 to a number associated with the multimedia advertisement. The telephone number may have been embedded in the search result web page. Via a computer microphone and speaker the searcher 125 may then communicate with personal at the call center associated with the multimedia advertisement.

To generate revenue, the owner of the sponsored search web server 115 may charge the advertiser for displaying multimedia advertisements in the search result web page 120. Alternatively or in addition, the owner of the sponsored search web server 115 may charge the advertiser when the searcher 125 clicks on the multimedia advertisement. This may, for example, be accomplished by communicating a message from the user terminal 130 to the sponsored search web server 115 when the searcher clicks the multimedia advertisement and deducting a money amount from an advertiser account associated with the multimedia advertisement when the searcher 125 has clicked on the multimedia advertisement.

At least one advantage to providing multimedia advertisements is that this may enable an advertiser to send a stronger marketing message. For example, a picture or video may be able to convey more information than a text advertisement listing. Another advantage is that multimedia advertisements may be streamed from a server other than the sponsored search web server 115. This may enable an advertiser to update the multimedia advertisement without having to go through the owner of the sponsored search web server 115. This may save the advertiser time to market.

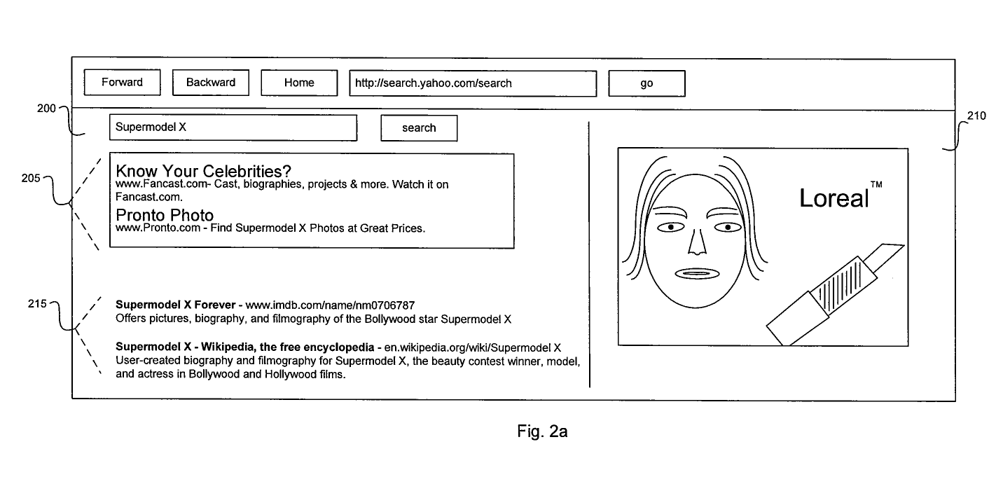

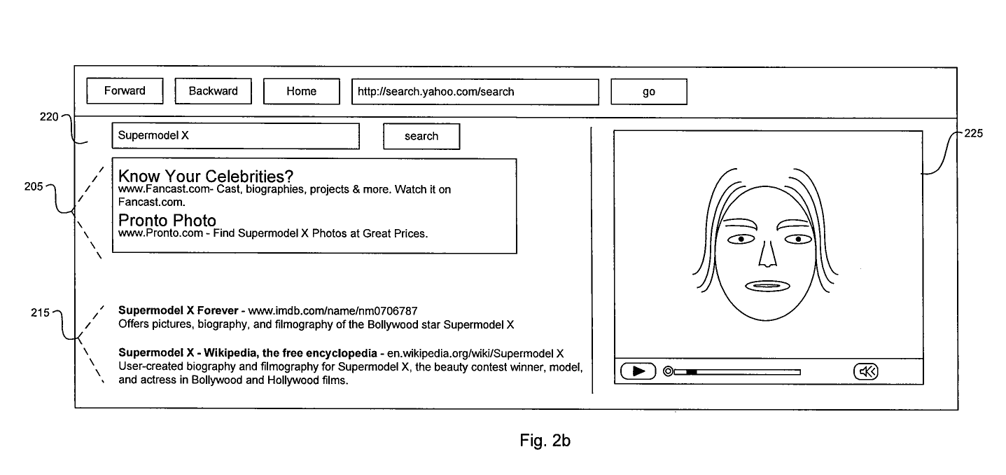

FIG. 2a is a web page with a photographic multimedia advertisement that may correspond to the search result web page 120, shown in FIG. 1. Shown in FIG. 2a is a search result web page 200, a group of advertisement listings 205, a group of other web page listings 215, and a photographic advertisement 210. The search result list web page 200 may be displayed via an internet browser operating on a user terminal in response to a search term being provided by a searcher. For example, the searcher 125 (FIG. 1) may submit the search term “Supermodel X” to a search engine, such as the sponsored search web server 115 (FIG. 1). The sponsored search web server may then communicate the search result list web page 200 to an internet browser running on the user terminal. The group of advertisement listings 205 and the group of other web page listings 215 may correspond to web pages that include the search term that may be stored in a database, such as the advertisement listing database 110 and database with website links 140 respectively, shown in FIG. 1. For example, a particular web page may include the text “Supermodel X” or an advertisement link may be associated with the text “Supermodel X.” As a result, links corresponding web pages and advertisements may be shown in the search result web page 200.

The photographic advertisement 210 may correspond to a relatively high resolution color photograph. For example, in response to the search term “Supermodel X”, the multimedia advertisement 210 shown may be that of a photographic advertisement with Supermodel X in the photo. In addition to or alternatively, the a video advertisement, such as the video advertisement 225 shown in FIG. 2b may be displayed. The video advertisement may feature a video with the same supermodel, as shown in FIG. 2a.

The image, audio, and/or video information associated with multimedia advertisement may be embedded within the search result web page 200. For example, a JPEG file corresponding to an image or a MPEG file corresponding to a video may be embedded. Alternatively, a link to a multimedia server with the multimedia advertisement information may be embedded within the search result web page 200. In this case, an internet browser displaying the search result web page 200 may stream the multimedia advertisement information from the multimedia server via the link.

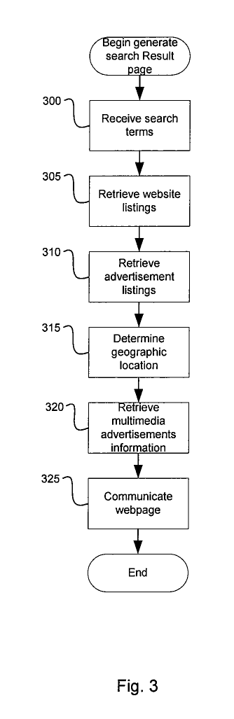

FIG. 3 is a flow diagram for generating a web page with multimedia advertisements. The blocks shown in the flow diagram may be implemented by the system shown in FIG. 1. Referring to FIG. 3, at block 300 search terms may be received. For example, a sponsored search web server 115 (FIG. 1) may, via a network connection, receive search terms specified by a searcher 125 (FIG. 1). The searcher 125 may have specified the search terms via an internet browser running on a user terminal 130 (FIG. 1).

At block 305, a database, such as the database with website links 140 (FIG. 1), may be searched to find links to web pages on the internet that include the search term. At block 310, another database, such as the advertisement listing database 110 (FIG. 1), may be searched to find advertisement listings associated with the search term. Advertisers may have paid to have their respective advertisement listings shown to a searcher submitting a particular search term. At block, 315 a geographic location of the searcher 125 may be determined. This may be accomplished by retrieving the internet address of the searcher 125 and determining, based on the address, the relative location of the searcher 125.

At block 320, multimedia advertisements may be retrieved from the multimedia advertisement database 145. An advertiser may have paid to have his multimedia advertisement displayed to a searcher in response to a particular search term. For example, an advertiser may have paid to have the search term “Supermodel X” associated with a multimedia advertisement such as the photographic and video multimedia advertisements 210 and 225 shown in FIG. 2a and FIG. 2b.

At block 325 a web page including the websites retrieved at block 305, the advertisements listings retrieved at block 315, and the multimedia advertisements retrieved at block 302 may be generated and communicated to the searcher. For example, a web page such as the web page 200 shown in FIG. 2a or FIG. 2b may be communicated to the searcher 125.

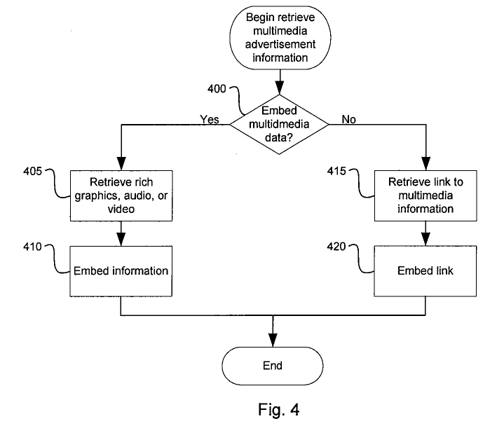

FIG. 4 is a flow diagram for retrieving a multimedia advertisement. At block, 400 a determination may be made as to whether the multimedia advertisement may be embedded in a subsequent search result webpage. If the multimedia advertisement is to be embedded, then at block 405 the information corresponding the multimedia advertisement may be included within the subsequent search result web page at block 410. For example, images, audio, and/or video may be embedded within the search result web page. The images may be represented in a JPEG format or any other format suitable for representing images. The audio may be represented in an MP3 format or any other format suitable for representing audio. The video information may be represented in an MPEG format or any other format suitable for representing video.

Referring back to block 400, if the determination made is not to embed the multimedia advertisement, then a link to a multimedia server with the multimedia information may be retrieved at block 415 by the sponsored search web server 115 and embedded within the generated search result web page at block 420. The link may refer to a multimedia server within the same network location as the sponsored search web server 115 or a different network location. For example, the link may refer to a multimedia server operating within an advertiser's network.

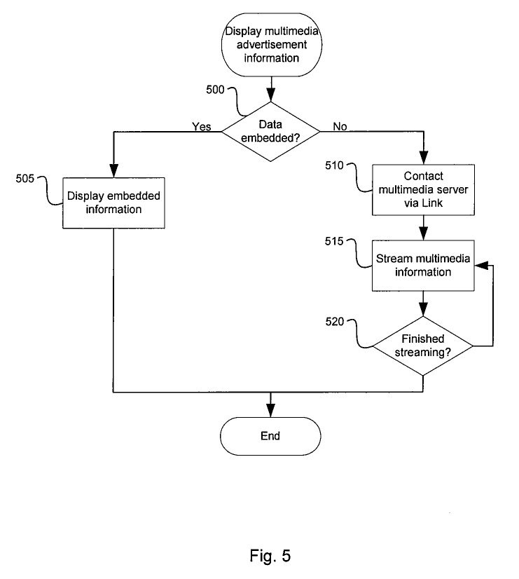

FIG. 5 is flow diagram for displaying multimedia information on an internet browser. At block 500, if the multimedia advertisement is embedded in the search result webpage then at block 505 the information may be utilized to render the image, audio, and/or video. Programs residing on the user terminal 130 and responsive to an internet browser operating on the user terminal 130 may be utilized to render the image, audio, and/or video information. For example, a JPEG or MPEG plug-in module in the internet browser may be utilized. Referring back to block 500, if a link is embedded within the search result web page, then at block 510, the internet browser may communicate with the multimedia server referred to by the link for the purpose of establishing a data stream corresponding to the multimedia information. At block 515, the information may be streamed from the multimedia server to the internet browser operating on the user terminal. At block 520, the streaming may continue until all the information has been transferred,

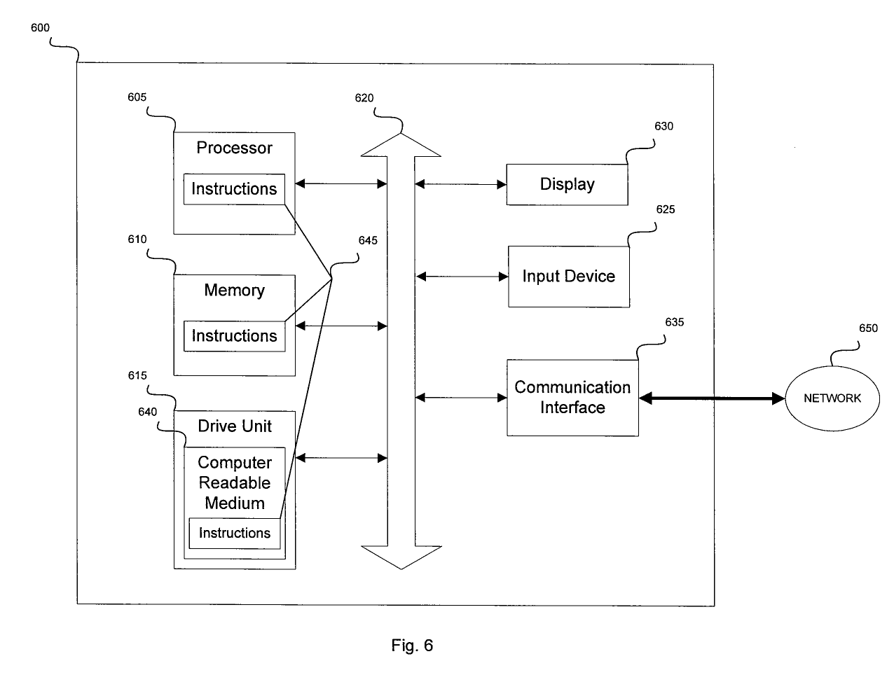

FIG. 6 illustrates a general computer system, which may represent a sponsored search web server 115, user terminal 130, multimedia server 100, or any of the other computing devices referenced herein. The computer system 600 may include a set of instructions 645 that may be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 645 (sequential or otherwise) that specify actions to be taken by that machine. In one embodiment, the computer system 600 may be implemented using electronic devices that provide voice, video or data communication. Further, while a single computer system 600 may be illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 605, such as, a central processing unit (CPU), a graphics processing unit (GPU), or both. The processor 605 may be a component in a variety of systems. For example, the processor 605 may be part of a standard personal computer or a workstation. The processor 605 may be one or more general processors, digital signal processors, application specific integrated circuits, field programmable gate arrays, servers, networks, digital circuits, analog circuits, combinations thereof, or other now known or later developed devices for analyzing and processing data. The processor 605 may implement a software program, such as code generated manually (i.e., programmed).

The computer system 600 may include a memory 610 that can communicate via a bus 620. For example, the advertisement listing database 110, database with website links 140, and multimedia advertisement database may be stored in the memory. The memory 610 may be a main memory, a static memory, or a dynamic memory. The memory 610 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 610 may include a cache or random access memory for the processor 605. Alternatively or in addition, the memory 610 may be separate from the processor 605, such as a cache memory of a processor, the system memory, or other memory. The memory 610 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 610 may be operable to store instructions 645 executable by the processor 605. The functions, acts or tasks illustrated in the figures or described herein may be performed by the programmed processor 605 executing the instructions 645 stored in the memory 610. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 600 may further include a display 630, such as a liquid crystal display (LCD), an organic light emitting diode (OLED), a flat panel display, a solid state display, a cathode ray tube (CRT), a projector, a printer or other now known or later developed display device for outputting determined information. The display 630 may act as an interface for the user to see the functioning of the processor 605, or specifically as an interface with the software stored in the memory 610 or in the drive unit 615.

Additionally, the computer system 600 may include an input device 630 configured to allow a user to interact with any of the components of system 600. The input device 625 may be a number pad, a keyboard, or a cursor control device, such as a mouse, or a joystick, touch screen display, remote control or any other device operative to interact with the system 600.

The computer system 600 may also include a disk or optical drive unit 615. The disk drive unit 615 may include a computer-readable medium 640 in which one or more sets of instructions 645, e.g. software, can be embedded. Further, the instructions 645 may perform one or more of the methods or logic as described herein. The instructions 645 may reside completely, or at least partially, within the memory 610 and/or within the processor 605 during execution by the computer system 600. The memory 610 and the processor 605 also may include computer-readable media as discussed above.

The present disclosure contemplates a computer-readable medium 640 that includes instructions 645 or receives and executes instructions 645 responsive to a propagated signal; so that a device connected to a network 650 may communicate voice, video, audio, images or any other data over the network 650. The instructions 645 may be implemented with hardware, software and/or firmware, or any combination thereof. Further, the instructions 645 may be transmitted or received over the network 650 via a communication interface 635. The communication interface 635 may be a part of the processor 605 or may be a separate component. The communication interface 635 may be created in software or may be a physical connection in hardware. The communication interface 635 may be configured to connect with a network 650, external media, the display 630, or any other components in system 600, or combinations thereof. The connection with the network 650 may be a physical connection, such as a wired Ethernet connection or may be established wirelessly as discussed below. Likewise, the additional connections with other components of the system 600 may be physical connections or may be established wirelessly.

The network 650 may include wired networks, wireless networks, or combinations thereof. Information related to business organizations may be provided via the network 650. The wireless network may be a cellular telephone network, an 802.11, 802.16, 802.20, or WiMax network. Further, the network 650 may be a public network, such as the Internet, a private network, such as an intranet, or combinations thereof, and may utilize a variety of networking protocols now available or later developed including, but not limited to TCP/IP based networking protocols.

The computer-readable medium 640 may be a single medium, or the computer-readable medium 640 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 640 may include a solid-state memory such as a memory card or other package that houses one or more non-volatile read-only memories. The computer-readable medium 640 also may be a random access memory or other volatile re-writable memory. Additionally, the computer-readable medium 640 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which included all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

From the foregoing, it may be seen that the embodiments disclosed herein provide an approach for providing multimedia advertisements in a sponsored search environment. Rather than simply displaying a static advertisement listings and requiring the searcher to navigate away from the search result page, this approach provides a multimedia advertisement within the search result page. The multimedia advertisement enables an advertiser to deliver a more effective advertising message to a searcher. This improves the likelihood that the searcher may utilized the services provided by the owner of the multimedia advertisement.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

1. A method for displaying advertisement listings in a sponsored search environment, the method comprising:
receiving, at a server located within a network location, a search term corresponding to a search request provided by a searcher via a terminal;
selecting at least one multimedia advertisement associated with the search term;
generating a search result comprising links to websites associated with the search term and information corresponding to the selected at least one multimedia advertisement; and
communicating the generated search result to the searcher via the terminal.

2. The method according to claim 1, further comprising determining a geographic location of the searcher and selecting multimedia advertisements that are geographically relevant to the searcher.

3. The method according to claim 1, wherein the information comprises at least one of: rich graphical information, audio, and video information.

4. The method according to claim 1, wherein the information comprises a link to a multimedia server.

5. The method according to claim 4, wherein the terminal retrieves at least one of: rich graphical information, audio, and video from the multimedia server.

6. The method according to claim 5, wherein the multimedia server is located at the network location.

7. The method according to claim 6, wherein the multimedia server and the server are one in the same.

8. The method according to claim 5, wherein the multimedia server is located at a second network location.

9. A machine-readable storage medium having stored thereon, a computer program comprising at least one code section for displaying advertisements in a sponsored search environment, the at least one code section being executable by a machine for causing the machine to perform acts of:
receiving at a server located within a network location a search term corresponding to a search request by a searcher via a terminal;
selecting at least one multimedia advertisement associated with the search term;
generating a search result comprising links to websites associated with the search term and information corresponding to the selected at least one multimedia advertisement; and
communicating the generated search result to the searcher via the terminal.

10. The machine-readable storage medium according to claim 9, wherein the at least one code section comprises code that enables determining a geographic location of the searcher and selecting multimedia advertisements that are geographically relevant to the searcher.

11. The machine-readable storage medium according to claim 9, wherein the information comprises at least one of: rich graphical information, audio, and video information.

12. The machine-readable storage medium according to claim 9, wherein the information comprises a link to a multimedia server.

13. The machine-readable storage medium according to claim 12, wherein the terminal retrieves at least one of: rich graphical information, audio, and video from the multimedia server.

14. The machine-readable storage medium according to claim 13, wherein the multimedia server is located at the network location.

15. The machine-readable storage medium according to claim 14, wherein the multimedia server and the server are one in the same.

16. The machine-readable storage medium according to claim 13, wherein the multimedia server is located at a second network location.

17. A system for displaying advertisements in a sponsored search environment, the system comprising:
a receiver configured to receive at a server located within a network location a search term corresponding to a search request by a searcher via a terminal;
a selector, in communication with the receiver configured to select at least one multimedia advertisement associated with the search term;
a search result generator in communication with the selector, configured to generate a search result comprising links to websites associated with the search term and information corresponding to the selected at least one multimedia advertisement; and
a transmitter in communication with the search result list generator configured to communicate the generated search result to the searcher via the terminal.

18. The system according to claim 17, further comprising circuitry that enables determining a geographic location of the searcher and selecting multimedia advertisements that are geographically relevant to the searcher.

19. The system according to claim 17, wherein the information comprises at least one of: rich graphical information, audio, and video information.

20. The system according to claim 17, wherein the information comprises a link to a multimedia server.

21. The system according to claim 20, wherein the terminal retrieves at least one of: rich graphical information, audio, and video from the multimedia server.

22. The system according to claim 21, wherein the multimedia server is located at the network location.

23. The system according to claim 22, wherein the multimedia server and the server are one in the same.

24. The system according to claim 21, wherein the multimedia server is located at a second network location.

25. A method for displaying advertisement listings in a sponsored search environment, the method comprising:
receiving, at a server located within a network location, a search term corresponding to a search request provided by a searcher via a terminal;
selecting at least one multimedia advertisement associated with the search term;
generating a search result comprising links to websites associated with the search term and information corresponding to the selected at least one multimedia advertisement;
communicating the generated search result to the searcher via the terminal; and
deducting a money amount from an advertiser account associated with the multimedia advertisement when the searcher has clicked on the multimedia advertisement.
